(19) United States
(12) Patent Application Publication
(10) Pub. No.: US 2009/0175723 A1
(43) Pub. Date: Jul. 9, 2009

(54) Undershot impulse jet driven water turbine having an improved vane configuration and radial gate for optimal hydroelectric power generation and water level control

(76) Inventor: Kenneth R. Broome, Woodside, CA (US)

Correspondence Address: WOODSIDE IP GROUP, P.O. BOX 61047, PALO ALTO, CA, 94306, US

(21) Appl. No.: 12/380,411

(22) Filed: Feb. 26, 2009

Related U.S. Application Data
(63) Continuation-in-part of application No. 11/244,453, filed on Oct. 6, 2005, now Pat. No. 7,503,744.

(51) Int. Cl. F03B 15/06; F03B 13/10

(52) U.S. Cl. 416/31; 290/54; 416/1

(57) ABSTRACT

A low-head impulse jet water turbine for electric power generation at irrigation canal drop structures, navigation dam spillways or other low head watercourses achieves renewable electric power generation at competitive cost. Kinetic energy of a low-pressure jet is employed in a way that enables numerous locations to generate electricity conveniently near points of use, from a renewable source at minimum cost. The equipment can be pre-assembled for minimum installation cost at sites with no existing impoundment and can be automatically raised clear of flood levels with built-in lifting equipment. Existing multi-span bridges offer convenient access for installation and maintenance. The system for raising the equipment also provides clear passage for fish migration.

### CROSS REFERENCE TO RELATED APPLICATION

This application is a continuation in part of U.S. Ser. No. 11/244,453, filed on Oct. 6, 2005.

### REFERENCE TO APPENDIX

The attached CFD Analysis of An Undershot Impulse Jet Hydropower Generator, University of Iowa, Nov. 11, 2008, provides an independent computational fluid dynamics analysis of features and aspects of the present invention and is submitted as Appendix A, and incorporated herein by reference.

### BACKGROUND

1. Field of the Invention

The field of the invention generally relates to hydroelectric power generation. In particular, the field of the invention relates to an undershot impulse-jet driven water turbine for generating a useful amount of electric power from a low head dam in watercourses such as an irrigation canal or a navigable river, or even in a watercourse without the need for a dam. A water turbine assembly comprises an automatically adjustable radial gate and hinged upper flap to maximize the hydraulic head and optimize the shape of a rectangular shaped jet. Radially disposed vanes are configured to maximize the kinetic energy extracted from each jet such that the need for a separate core pipe is avoided unless needed for structural purposes.

2. Background of Related Art

Conventional hydro turbines for generation of electric power contain a speed-increaser gear unit and an electric generator either internally contained within the water turbine or mounted on a platform located above the hydro turbine. Such waterwheel driven generating units are disclosed in the inventor's own U.S. Pat. No. 5,440,175, entitled “Waterwheel-Driven Generating Unit,” issued Aug. 8, 1995, and in U.S. Pat. No. 6,208,037, “Waterwheel-Driven Generating Assembly,” issued Mar. 27, 2001, both of which are incorporated herein by reference.

Generation of electricity at very low-head dams (less than about 15 feet difference between water levels upstream and downstream of a dam) has become uncompetitive with other forms of electric power generation. This is due to a lack of suitable equipment that can be installed for a total capital cost per kilowatt of capacity lower than that of other forms of generation from renewable sources, such as wind power, wave power and solar energy that have no fuel costs. With no hydro generating equipment designed specifically for very low-head sites, the typical approach until now has been to adapt the same types of hydro turbine used at higher-head sites to the lower head sites.

There have been two problems with this approach however. First, the volume of water required to develop the same power output increases inversely to the reduction in head, thereby requiring larger diameter equipment and greater amounts of excavation and concrete for the water passages, all at progressively higher cost for diminishing revenue. Secondly, the proportions of cost required to construct the civil works actually increases faster than the cost of the equipment.

Consequently, what is needed is a more cost-effective water turbine driven generating unit characterized by installation costs reduced to the absolute minimum and wherein power generating equipment is designed for ease of shop fabrication, pre-assembly, transportation and installation at minimal expense.

Impulse-jet turbines of the Pelton or Turgo type using jets of circular cross-section have been used for many years to generate electricity at locations where the available hydraulic head is greater than about 15 meters (about 50 feet). According to the “Guide to Hydropower Mechanical Design” prepared by the American Society of Mechanical Engineers Hydro Power Technical Committee, sites having lower heads were considered more suitable for hydro development using reaction turbines of the Kaplan or propeller type, based on relative efficiencies and the economics of equipment and installation costs. As previously mentioned, however, at very low heads, the cost of both equipment and the civil works needed for conveying water to and from the equipment increases disproportionately in comparison to the value of power produced.

Using presently available equipment and installation methods results in the cost of power becoming uncompetitive at hydraulic head differences less than about 15 feet. Therefore, what is needed is an undershot impulse-jet type of water turbine designed to maximize the energy obtainable from a given volume of discharge and hydraulic head by utilizing the potential pressure and volume of a rectangular jet impinging on vanes of a turbine spanning a full width of waterway at the bottom of their travel rather than using mainly a gravity effect of a conventional overshot water turbine, or the kinetic energy in a flowing stream that traditionally has been used to drive the reaction type of undershot water turbines. The higher velocity of the jet facilitates a greater volume of discharge and rate of rotation with consequent higher power output than either a gravity driven overshot wheel or a reaction type of undershot water turbine can develop from the same head and flow.

Up to now, conventional very low head hydro generation systems have been uneconomic power sources, and are not competitive with other forms of non fuel based energy production such as wind, wave or solar power. Conventional low head hydro equipment systems focus on increasing efficiency, resulting in increased manufacturing and installation costs. Efficiency is not the economic key to success. Rather, the key to competitive success for low head hydropower is to minimize the cost of investment per kilowatt hour of production. Therefore, what is needed is a low-head hydro generation system and method that maximizes kilowatt-hour production while minimizing investment in component cost and installation. Furthermore, the diameter and consequently the cost of an impulse-jet driven undershot water turbine can be much less than that of an overshot water turbine designed to develop power from a particular head, since the diameter of the impulse-jet water turbine can be much less than the available head.

### SUMMARY

In accordance with the foregoing and other objectives, an undershot water turbine is provided for placement in a watercourse with or without an impoundment, such as an irrigation canal, or navigable river. The water turbine assembly comprises an automatically adjustable radial gate that optimizes the hydraulic head at the jet and maintains the upstream water level within narrowly defined limits at any predetermined elevation, thereby providing watershed sustainability—a feature of significant value in irrigated areas served by gravity flow from the canal.

An aspect of the invention adapts the impulse type of turbine to very low-head sites by using a wide aspect ratio water turbine configuration with a single full-width rectangular shaped jet directed at the lowest point of travel of each vane on the rotor. This single jet is controlled by a radial gate that is raised to increase the height of the opening and jet, and lowered to reduce the height of the jet and rate of discharge. This type of water turbine assembly thereby acts as its own dam, creating its own head that can be greater than the diameter of the water turbine itself by adding the hinged flap described below.

Another aspect of the invention provides a modular water turbine, radial gate, speed increaser and generator assembly, wherein the wide aspect ratio rotor and associated radial gate are disposed across the full width of a low head watercourse such as an irrigation system, canal, or ditch without the need for a permanent impoundment. The water turbine assembly forms the impoundment and creates its own head. The modular system can be installed in place by a crane or assembled in place in a low head watercourse previously unavailable for economic hydroelectric power generation.

The lower boundary of the jet is formed by a sole plate disposed in the bed of the waterway at an elevation such that the water level downstream of the installation is usually at a lower level than the top of the sole plate. Such a relationship ensures that the jet impinges on the vanes at atmospheric pressure rather than being submerged in tailwater.

The shape of the sole plate is curved to conform to the boundary conditions favoring minimum expansion of the jet as it impinges on each vane of the-water turbine. The sole plate in conjunction with the shape of the radial gate forms the jet in a hydraulically efficient way such that the emerging jet is optimized and without expansion, thereby increasing the kinetic energy transferred from the water jet into the vanes of the turbine.

The water turbine comprises a rotor having a longitudinal axis disposed substantially perpendicular to the flow of the jet. A series of curved vanes are provided substantially in parallel with the longitudinal axis of the rotor and disposed radially about the rotor's surface, such that a major surface or leading edge of each vane is disposed for substantially perpendicular alignment with respect to the flow vector of the jet. In accordance with an aspect of the invention, the leading edge of each vane is provided with a stiffening element, such as a support plate, that forms a continuous flow control surface extending from the leading edge of each vane to the base of a successive vane. In rotation, the support plate's control surface establishes approach conditions for the jet as it successively impacts each vane, and defines a streamlined flow path for the jet, such that turbulence and vortices in the jet are substantially eliminated as the jet approaches the leading edge of each successive vane. This has been found to increase advantageously the amount of kinetic energy that can be extracted from the jet. Efficiencies of about 85 percent may be realized. See Appendix A page 13, CFD Analysis of An Undershot Impulse Jet Hydropower Generator, University of Iowa, Nov. 11, 2008; incorporated herein by reference. Such an arrangement also stiffens the rotor and reduces the need for a separate core pipe.

A hinged flap can be attached to the upper edge of the radial gate in order to increase the effective pressure at the elevation of the jet beyond the diameter of the wheel itself. This flap can be adjusted to achieve maximum upstream water level at any position of the radial gate and is curved to the same radius as the radial gate such that is can be lowered to discharge flows in the waterway that are higher than can be passed through the water turbine under the radial gate.

An inclined steel bar trashrack is installed on the upstream side of the water turbine such that trash will collect at the upper end of the trash rack. Trash can be removed either manually or by machine from the deck of the installation.

An additional aspect of the invention maintains a desired upstream water surface elevation by locally or remotely opening or closing the radial gate and superposed flap, regardless of stream flow within the limits of the design. The purpose of maintaining the desired upstream water surface elevation advantageously enables control of water surface elevations in irrigation canals and navigable rivers. This can avoid flooding and can achieve gravity flow into selected adjacent irrigation systems as well as maintaining necessary minimum depth for navigation. Control of water surface elevations in irrigation canals is a primary operational constraint that in many existing canals is achieved by raising or lowering the tops of weirs formed by manually placing or removing wooden boards one on top of another in slots supported by steel posts or concrete abutments.

This aspect of the invention includes the installation of automatic or remotely controlled radial gates on a series of water turbines disposed throughout a watershed or irrigation system to control water flow automatically throughout such a system for optimal watershed management. The automatic control system becomes financially feasible by means of the source of revenue derived from the sale of electric power in addition to the saving in the cost of labor necessary to manually adjust the height of weir boards.

In an aspect of the invention, a sensor is disposed upstream of each radial gate for providing an output signal indicating a sensed surface water level. In response to the output signal of the water level sensor, the radial gate is raised or lowered by a desired amount to achieve a predetermined water level upstream of the radial gate. The data from water level sensors at a plurality of radial gates located sequentially along the length of a water course also may be analyzed at a central processing unit and a control signal sent for remotely actuating selected radial gates to be raised or lowered to achieve a desired overall water level upstream of each radial gate for watershed management or water allocation in an irrigation system, or the like.

An upstream water level sensor also is used to control the opening and closing of a radial gate in order to maintain a predetermined upstream water surface elevation under variable rates of flow.

A plurality of radial gates and associated water level sensors may be disposed in a concatenated fashion across the width of a river, for example, either just upstream of an existing multi-span bridge or at an existing low-head dam with control gates. The water level sensor at each radial gate can be monitored and each radial gate automatically lowered or raised to maintain the overall water level at a predetermined elevation. Arrangements can be made to raise the complete assembly above flood level or to provide maintenance access by means of synchronized jack screws or hydraulic cylinders located at each corner of the platform. Such mechanisms also can be used to vary the operating elevation to maximize the hydraulic head with changeable discharges that cause the downstream water level to rise and fall while maintaining a constant upstream water level.

The controlled discharge in both irrigation canals and rivers used for navigation must continue without interruption due to mechanical or electrical malfunction. Another aspect of the invention is an automatic release of the sole plate that forms the lower boundary of the impulse-jet. Release of the sole plate is initiated by an excessive rise in upstream water level of the same upstream level sensor used normally to position the radial gate. The full discharge then flows under the water turbine.

### BRIEF DESCRIPTION OF THE DRAWINGS

FIG. 1A is a vertical cross section taken on Line 1-1 of FIG. 3 of a water turbine generating unit constructed in accordance with an aspect of the invention.

FIG. 1B is a vertical cross section taken on Line 1-1 of FIG. 3 of a water turbine generating unit showing a plurality of vanes with leading edges constructed in accordance with an aspect of the invention.

FIG. 2A is a detailed cross-section of the variable height opening or nozzle that forms the jet that impinges on each vane of the wheel as the turbine revolves.

FIG. 2B is a detailed cross-section of FIG. 2A showing details of the leading edges of the rotor vanes for reducing turbulent flow of the jet resulting in increased extraction of kinetic energy from the jet constructed in accordance with an aspect of the invention.

FIG. 3 is a front view from downstream of a water turbine generating unit installed in an irrigation canal and constructed in accordance with an aspect of the invention.

FIG. 4 is a plan view of a water turbine-generating unit, installed in an irrigation canal, wherein the water wheel generating unit acts as a dam and creates its own head in accordance with an aspect of the invention.

FIG. 5 is a front view from downstream of an installation at an existing multi-span bridge or navigation dam showing the modular support structure for the water turbine, enabling the water turbine and generator assembly to be quickly and easily constructed in an existing watercourse such as a river or diversion channel in accordance with an aspect of the invention.

FIG. 6 is a plan view of a water turbine installed just upstream of an existing multi-span bridge in accordance with an aspect of the invention.

FIG. 7 is a section through the water turbine showing the moveable sole plate that releases discharge in the event of turbine stoppage in accordance with an aspect of the invention.

FIG. 8 is a side view of the rotor of a water turbine showing sections of vanes in staggered arrangement in accordance with an aspect of the invention.

### DESCRIPTION OF THE PREFERRED EMBODIMENTS

Design of the water turbine and vanes and the location of speed increaser and generator in coaxial arrangement within the hub of the water turbine are described in U.S. Pat. No. 5,440,175, “water turbine-Driven Generating Unit,” and in U.S. Pat. No. 6,208,037, “water turbine-Driven Generating Assembly,” which are incorporated herein by reference.

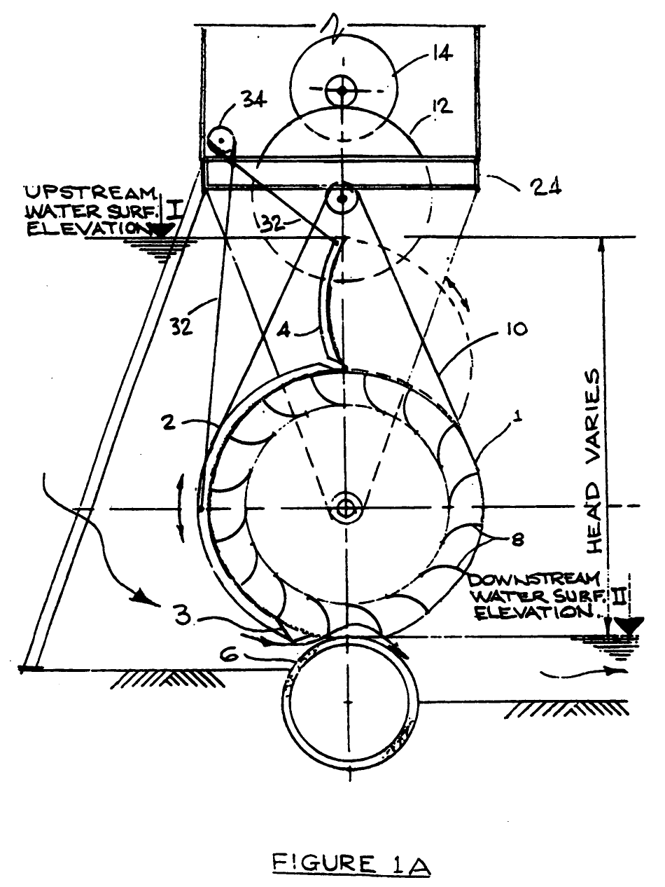

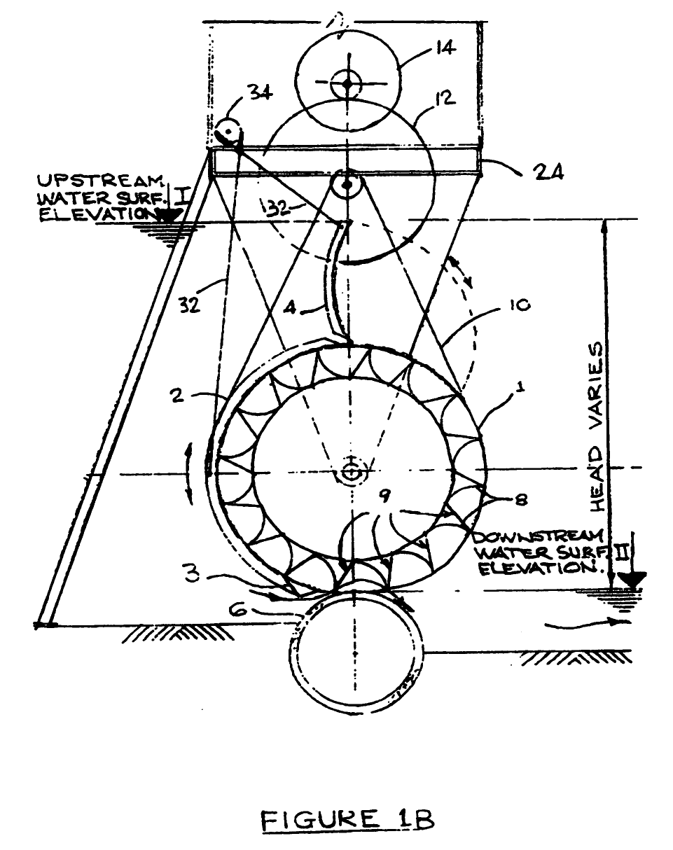

Referring to the drawings, FIG. 1A shows a water turbine comprising a rotor 1 with a radial gate 2, a moveable flap gate 4, and sole plate 6 for directing water flow together with the radial gate 2 into a plurality of vanes 8 disposed radially about the rotor 1. A chain drive 10 is coupled with a speed increaser 12 and spur gear arrangement that provides an appropriate speed for generator 14. Preferably the speed increaser 12 is an epicyclical sun and planetary gear arrangement, which takes the speed of rotation of water wheel 1 and converts it to a useful speed for the generator, for example 1800 rpm. The speed increaser can provide on the order of a 50:1 step-up for generator 14.

FIG. 1B shows a water turbine comprising rotor 1 with a radial gate 2, a moveable flap gate 4, and sole plate 6 for directing water flow together with the radial gate 2 into a plurality of vanes 8 disposed radially about the water turbine 1. In accordance with an aspect of the invention, the water turbine 1 comprises a rotor having a longitudinal axis disposed substantially perpendicular to the flow of the watercourse and to the jet. A series of vanes are provided substantially in parallel with the longitudinal axis of the rotor and disposed radially about the rotor's surface, such that a leading edge surface of each vane is disposed for substantially perpendicular alignment with respect to the flow vector of the jet. In accordance with an aspect of the invention, the leading edge of each vane is provided with corresponding supporting member, such as a steel plate 9. Supporting member 9 may be a support plate, or other means for supporting or stiffening the leading edge of each vane 8 such that turbulence in the jet formed by nozzle 3 and sole plate 6 is substantially reduced as it approaches the leading edge of each vane 8.

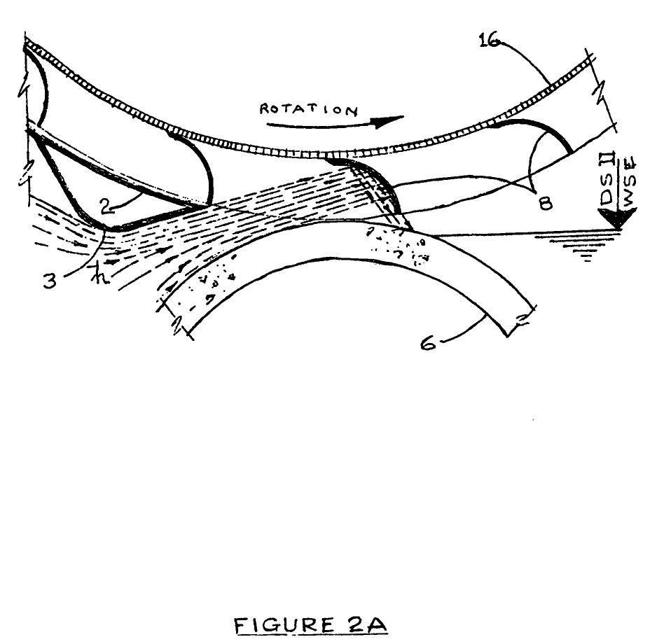

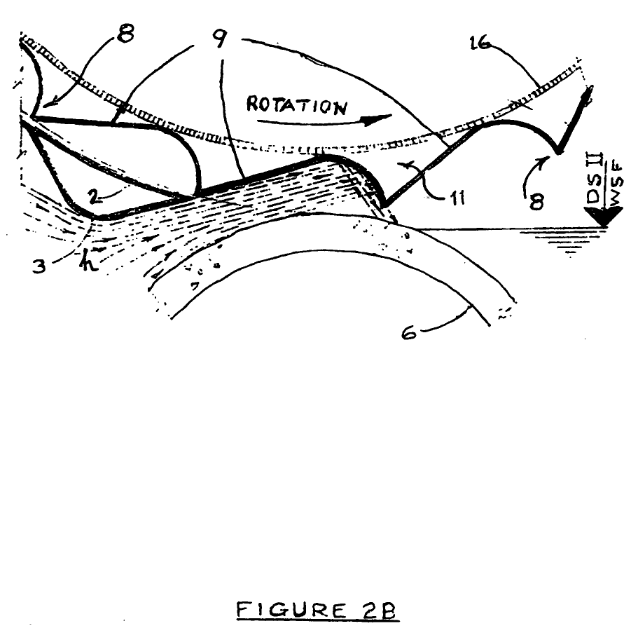

Referring to FIG. 2A, the lower edge of the movable flap gate 4 is modified by the addition of a curved flow nozzle 3 to shape the jet for optimum performance. The exact shape of this nozzle will be determined by Computational Flow Dynamic Analysis to suit the particular conditions at each installation.

Referring to FIG. 2B, the series of curved vanes 8 are provided along the longitudinal axis of rotor 1, substantially coextensive with the length of the rotor 1, and are disposed radially about the rotor's surface. Each vane 8 has a leading edge defining a major surface disposed for substantially perpendicular alignment with respect to the flow vector of the jet h developed by nozzle 3. In accordance with an aspect of the invention, the leading edge of each vane 8 is provided with a coextensive stiffening element such as support plate 9. Support plate 9 or other means for supporting the leading edges of vanes 8 defines a flow control surface coextensive with each vane, extending from the distal end of the leading edge of a first vane to the base of the leading edge of a successive vane. In rotation, the control surface formed by supporting member 9 sets up an approach condition for the jet h as it approaches each successive vane. Supporting member 9 in rotation aligns with the jet h to define a flow path that provides a substantially constant streamlining of the jet h for increasing the percentage of kinetic energy recoverable from the jet successively as the jet approaches each vane leading edge.

That is, in rotation, the control surface of supporting member 9 defines a flow path that effectively aims the jet h and streamlines the flow vector for direct impact with out deflection on the leading edge of each successive vane. Accordingly, turbulence, turbulent flow, formation of vortices between vanes, and/or divergence or expansion in the jet are substantially eliminated each time as the jet approaches the leading edge of a successive vane.

The streamlining of the jet, and consequent reduction of turbulent flow at the vanes, advantageously maximizes the amount of kinetic energy available in the jet and the amount of energy that the vanes and rotor can extract from the jet. This results in significantly higher efficiency in hydroelectric power conversion, up to as high as 85 percent. See page 13 of Appendix A, CFD Analysis of An Undershot Impulse Jet Hydropower Generator, University of Iowa, Nov. 11, 2008; incorporated herein by reference.

Such an arrangement also stiffens the overall rotor 1 of the water turbine and reduces the need for a separate core pipe. This greatly adds to the strength of the rotor in acting as its own dam or impoundment for a watercourse.

Referring again to FIG. 2B, the underside of each curved vane 8 and underside of the control surface of support plate 9 define a cavity 11. Cavity 11 can be sealed to prevent ingress of water. Alternatively, cavity 11 is injected with foam plastic or filled with equivalent lightweight, non-wetting, non-absorbent material to prevent ingress of water into the cavity. The sealing and/or filling of the cavity with a lightweight, non-absorbing waterproof material stabilizes the rotor and prevents imbalance or uneven rotation of the rotor, further increasing the efficiency of hydroelectric generation.

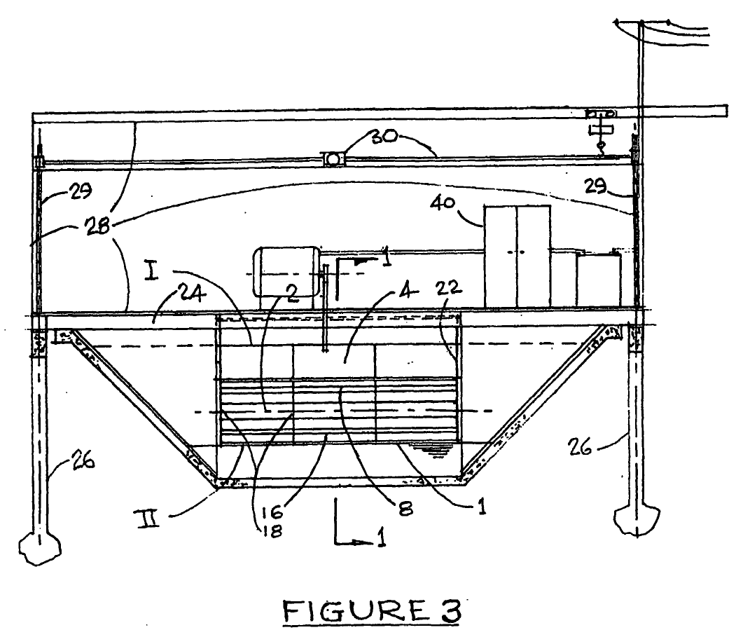

Referring to FIGS. 1B and 3, an undershot water turbine is operable between headwater I and tailwater II and comprises a central metal cylinder or rotor 1 generally designated 16 that is provided about its circumference with multiple sets of vanes 8 that are fixedly attached at intervals and at each end to flat circular metal discs 18 (FIG. 3). The leading edge of each curved vane is supported by a straight piece of steel plate 9 that also acts as a guide or flow control surface to prevent the jet being deflected prematurely before impacting the preceding curved blade. The water turbine 1 comprises a low head impulse turbine that may be constructed in any structurally rigid length to span a watercourse.

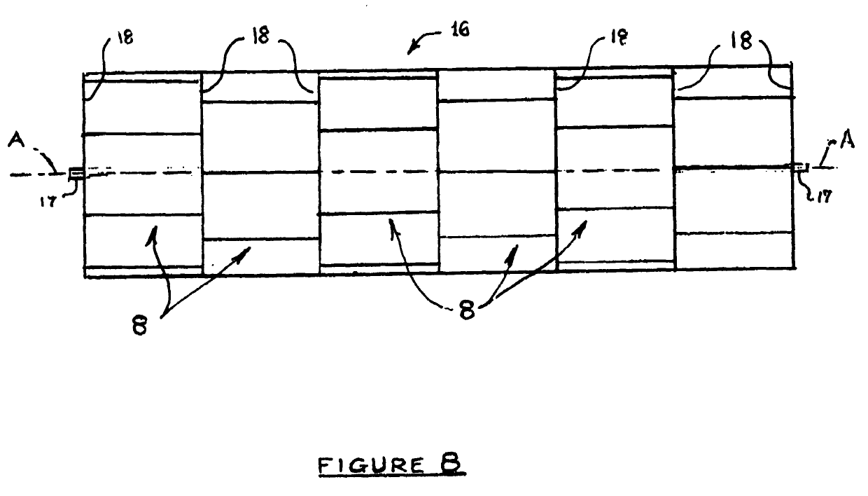

Referring to FIGS. 3 and 8, the water turbine comprises a wide aspect ratio rotor 1 In combination with flap 4 and radial gate 2, the wide aspect ratio water turbine creates a useful head of water without the necessity of an impoundment. Rigidly attached metal discs 18 are disposed radially about the circumference of the rotor to provide support to the vanes 8. In a preferred embodiment (FIG. 8), rigidly attached metal discs 18 are spaced apart along the longitudinal axis of the rotor 1 and separate the vanes into sectors or sets, such that a first set of vanes is displaced in a circumferential manner about the rotor with respect to a an adjacent set of vanes. That is, the vanes between a pair of circular discs 18 are staggered to avoid compounding the impact effect of each vane receiving an impulse simultaneously in each portion of the turbine and causing unnecessary vibration. The sets of vanes can be any convenient length along the longitudinal axis A of the rotor, for example, about five feet or longer.

It will be appreciated that the water turbine is characterized by a wide aspect ratio. That is, the water turbine can be constructed in any transportable length to span the entire width of a low head watercourse such as an irrigation system canal, navigation canal, tidal estuary, or the like. The water turbine acts as its own dam, creating its own useful head from a watercourse without the need for an impoundment provided the banks are high enough to contain the head difference. In the case of a low head, wide water channel, a plurality of water turbine generating units can be disposed side by side across the entire width of the channel to thereby create a useful head of water for hydro power generation with minimal installation cost, particularly if there is an existing bridge available for access during both installation and subsequent operation.

Referring to FIGS. 3 and 8, the rotor 1 comprises a central metal cylinder 16 that is provided with stub axles 17 that project at each end beyond the circular metal end discs a distance sufficient to provide space for standard journal bearings that each support half the weight and water pressure on the water turbine and transfer the load through a steel suspension frame 22 to the transverse girders 24 that span the waterway and convey the load to foundations 26 on either side of the waterway. It is important to provide bearings at either end of the water turbine that are capable of withstanding some degree of end loading as well as transverse loads. In this regard, the added surface area and strength provided by support plates 9 add to the strength of the rotor and its ability to withstand transverse loads in acting as its own dam or impoundment for a watercourse.

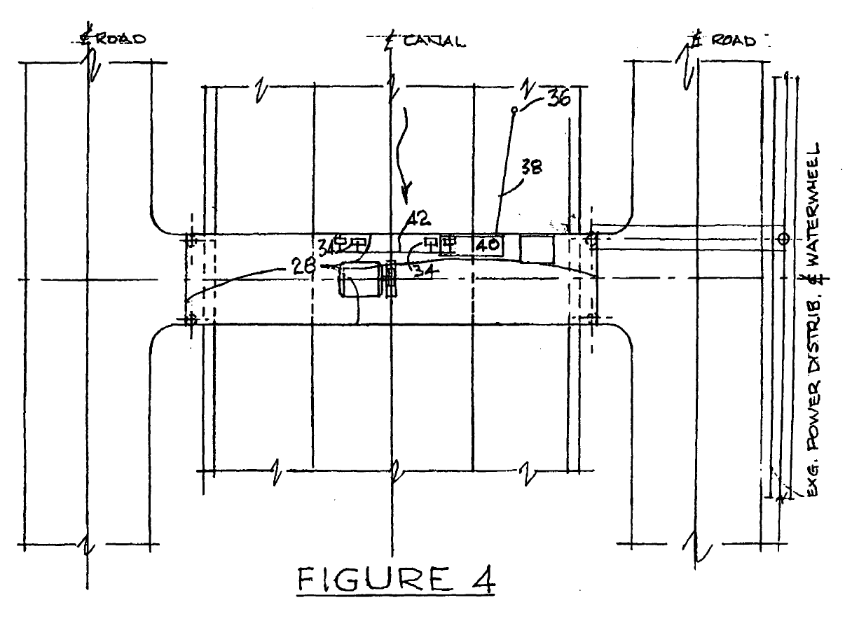

Referring to FIGS. 3 and 4, it will be appreciated that the steel suspension frame and transverse girders can be provided as a modular box structure 28 to accommodate the water wheel assembly and enable the water turbine to be installed as a modular unit for low cost placement in a typical low head watercourse such as an irrigation canal. The box structure 28 provides support for the water turbine gear system and generator assembly. The box structure 28 can be provided as a prefabricated structure. Such a prefabricated box structure 28 can be made from either painted or galvanized steel for both strength and durability.

If it is necessary to lift the water turbine assembly completely clear of the water channel to provide maximum flood discharge capacity, a system of four synchronized jack screws can be provided, one at each corner of the platform that is part of the box structure. These jack screws 29 can be driven by a system of horizontal shafts and gears from a single electric motor 30. Alternatively a system of hydraulic cylinders can be used to raise and lower the platform using a hand-operated or electrically driven hydraulic pump to provide the necessary power.

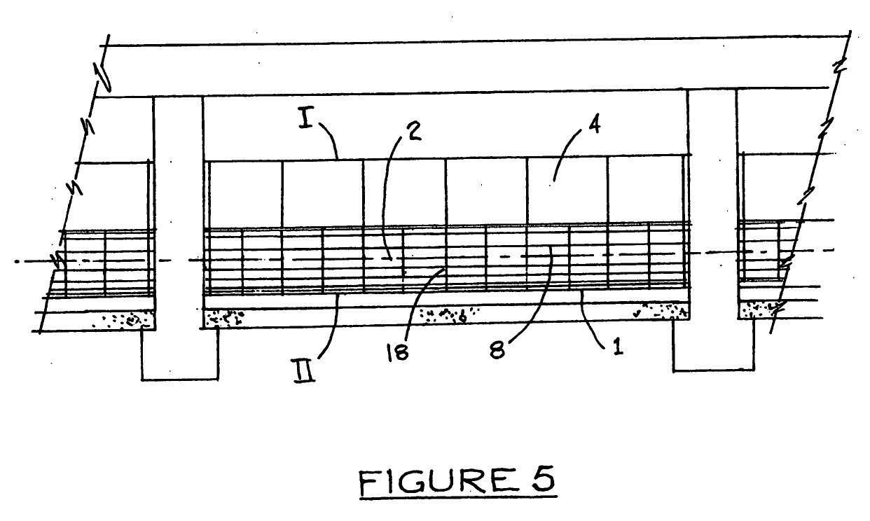

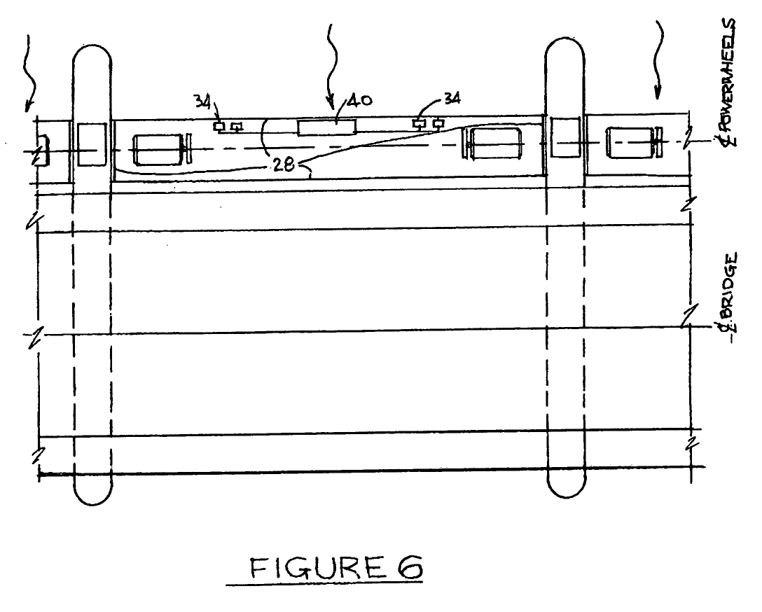

With reference to FIGS. 5 and 6, being an elevation from downstream and a plan view, respectively, of an installation of the undershot impulse jet driven water turbine assembly immediately upstream of an existing bridge across a river having banks high enough to develop a head difference of up to, for example, 20 feet during average annual discharge. The bridge may have multiple spans each one of which could accommodate a water turbine. The bridge could provide access for both initial installation and subsequent maintenance.

With reference to FIG. 1, a chain drive 10 may be employed at one or both ends of the water turbine with a drive sprocket of diameter equivalent to that of the water turbine and a driven sprocket of about ⅙ of that diameter. The driven sprocket in turn causes a large spur gear on the same shaft to engage a much smaller gear on the generator shaft with an overall ratio of water turbine speed to generator speed of 1:50. However, this ratio can be increased to 1:80 using the epicyclical gear arrangement described previously.

A curved steel radial gate 2 is provided on the upstream side of the water turbine. The radial gate rotates on guide bearings about the center of the water turbine and controls the height of the opening at the bottom of the water turbine. The radial gate 2 is supported radially and laterally on bearings incorporated in each end of the support frames with a low friction surface to facilitate movement.

Referring to FIGS. 1A and 1B, the radial gate 2 can be raised or lowered by convenient control means, such as steel cables 32 operated by winches 34 mounted on the steel girders 24 that support the water turbine. The radial gate 2 forms the upper surface of the rectangular jet of water under pressure from the upstream water surface elevation that drives the water turbine by impingement of the jet on each vane in the wheel in turn as it passes in front of the jet.

The radial gate 2 has an inside radius slightly greater than the outside radius of the water turbine in order to provide sufficient clearance to prevent contact. The radial gate rotates on guide bearings about the center of the water turbine and controls the height of the opening at the bottom of the water turbine. Referring to FIGS. 1A through 2B, the radial gate 2 forms the upper surface of the jet of water under pressure from the upstream water surface elevation that drives the water turbine by impingement of the jet on each vane on the wheel in turn as it passes in front of the jet. The jets of water are indicated by the arrows in region h (height in feet of the opening below the radial gate and above the top of the sole plate) in FIGS. 2A and 2B. The lower surface of the jet is formed by the curved surface of a metal or concrete sole plate 6 located in the bed of the waterway immediately beneath the water turbine. The shape of the sole plate 6 is designed to focus the jet downstream of the orifice so that the jet neither contracts nor expands. The pressure differential created by the sole plate in combination with the radial gate increases the kinetic energy of water discharged by the jet and hence the energy that is transferred to the vanes in the turbine. The sole plate 6 confines the lower boundary of the jet to a level above the downstream water surface elevation II and is shaped in a curve that conforms to hydraulic conditions that minimize contraction of the jet as it emerges below the bottom of the gate.

The radial gate 2, when raised, provides a rectangular-shaped opening in close proximity to the bottom of the water turbine to enable a jet of water to impinge on each vane in turn causing the water turbine to rotate. The radial gate 2 also causes the water level upstream of the water turbine to rise until the discharge through the jet is equal to the inflow from upstream.

A hinged flap 4 mounted on top or attached to the upper edge of the radial gate 2 permits the upstream water level to be raised higher than the top of the water turbine, thus increasing the power produced for a particular diameter of water turbine. This flap 4 can be lowered by steel cables 32, operated by winches 34 mounted on the support girders 24 such that the flap conforms to the shape of the water turbine and permits discharge of water flow in excess of the capacity of the water turbine. Thus, the hinged flap 4 in combination with the radial gate 2 can increase the upstream water surface elevation when maintained in an upright position, or can release flows greater than the capacity of the water turbine when lowered to conform to the surface of the water turbine.

Control of water surface elevations in irrigation canals is a primary operational constraint that in many existing canals can be achieved only by raising or lowering the tops of weirs formed by manually placing or removing horizontal wooden boards one on top of another in slots supported by steel posts or concrete abutments. The purpose of maintaining the desired upstream water surface elevation may be simply to avoid flooding by overtopping the banks, or to achieve gravity flow into adjacent irrigation systems. The invention described herein will make the installation of automatic or remotely controlled radial gates financially feasible by providing a source of revenue in the sale of power to pay for them in addition to the saving in cost of the labor necessary to manually adjust the height of weir boards.

It will be appreciated that the radial gate 2 in combination with the hinged flap 4 can provide a previously unattainable degree of control over the flow and dispersion of water upstream of the water turbine in comparison with conventional systems. Such control can be achieved automatically in response to changing water levels. As shown on FIG. 4, a water level sensor means 36 is disposed upstream of the radial gate 2 and flap 4 for sensing upstream water level. In response to a change in water level, the water level sensor 36 provides an output signal representative of sensed water level over a wired or wireless communication channel 38 to an input port of controller 40. Controller 40 includes a microprocessor that analyzes the signal from water level sensor 36. If a change in the height of the flap or radial gate is desired to maintain the upstream water level within a predetermined range, controller 40 sends a control signal over wired or wireless communication channel 42 to a motor or other means for raising or lowering the flap and/or radial gate, such as winches 34. The radial gate and/or the flap are then raised or lowered a predetermined amount to keep the upstream water level I at a desired level or within a predetermined range. This aspect of the invention can maintain a desired upstream water surface elevation by locally or remotely opening or closing the radial gate 2 and superposed flap 4, regardless of stream flow within the limits of the design.

The controller 40 also can be communicatively linked with additional water level sensors remotely located at other water turbines upstream or downstream in an irrigation system and receive signals representative of water levels at such remote locations. This would make possible the coordinated monitoring of water level data and improved control of water resources throughout an irrigation system.

### Emergency Water Passage Clearance in Case of Water Turbine Stoppage

In many locations, the undershot impulse-jet driven water turbine will use all of the water flowing in the canal or natural stream in order to generate electric power. An upstream water level sensor 36 controls the opening and closing of the radial gate as previously described with respect to FIG. 4 in order to maintain a predetermined upstream water surface elevation under variable rates of flow. There are various possible reasons for the runner, or rotor 1, gear train or even the generator to stop rotating while in operation, such as a solid object jamming one of the runner vanes, or gear wheels. There might also be a failure in the electrical generation and control system. Whatever the cause of such a stoppage of runner rotation, there would be an immediate need to remove the complete water turbine generating system from the water passage and/or provide an alternate water passage around the obstruction in order to prevent upstream flooding and to supply an equivalent flow to the downstream users.

An additional aspect of the invention comprises the installation of a control mechanism, controller 40, responsive to upstream water level sensor, 36 to lift the entire water turbine, supporting structure, and electrical generating system vertically out of the waterway whenever the upstream water level sensor detects a reading more than a predetermined distance above its normal elevation or a predefined safety limit. The means for accomplishing such an emergency lifting response, includes not only the lifting mechanism itself, such as a cable and winch system, hydraulic jacks, or jackscrews, but also an automatically starting diesel or gasoline electric power generator to supply a dedicated source of energy for operating such equipment in case the normal power supply would also be interrupted.

Alternatively, and depending on the conditions at a particular site, it may be feasible to allow the water turbine and its supporting platform to be displaced horizontally in a downstream direction by the normal hydraulic water pressure on the radial gate. Such displacement would allow the free flow of water under the bottom of the wheel and prevent any flooding upstream. A motorized rack and pinion method of supporting each end of the water turbine support platform would permit return of the system to its operating position after the problem causing the blockage has been solved. Release of the water turbine system when the blockage occurs, is initiated by an excessive increase in the upstream water level detected by a float sensor actuating a release pin in a link to an upstream anchor.

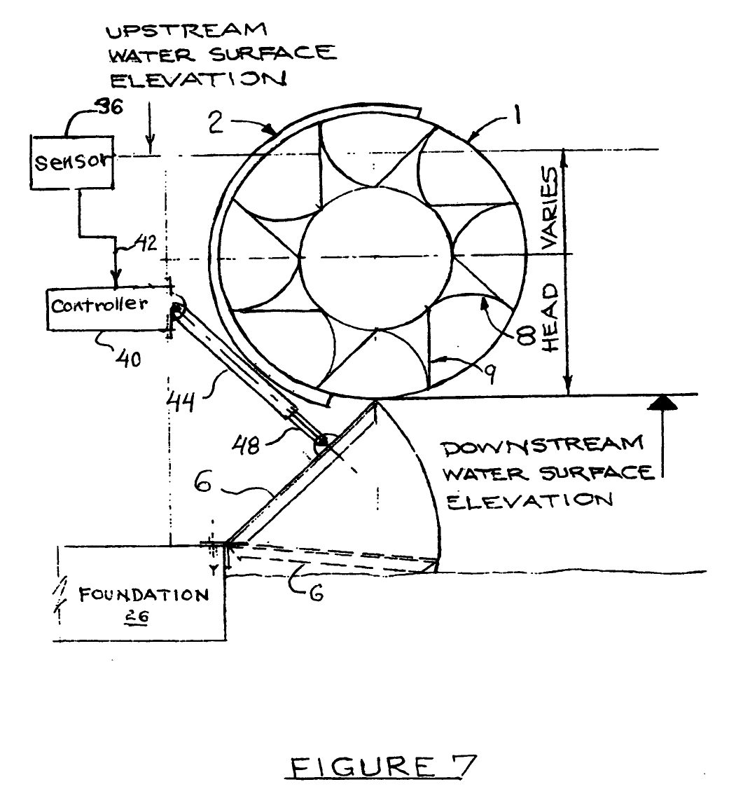

Yet another way to achieve the release of water impounded by stoppage of the turbine runner is to drop or otherwise move the sole plate to a safe position, thus permitting free flow under the bottom of the runner or rotor. Referring to FIG. 7, the elevation of the toe of the sole plate 6 is controlled in any event to match the vertical position of the runner or rotor 1 which is raised and lowered to match variable tail water elevation. The range of movement will be designed to drop the sole plate 6 enough to pass the full discharge, clear of the bottom of the runner, in the event of a stoppage. Choice between the various ways to maintain full discharge under emergency conditions will depend on the configuration at any particular site. In an embodiment shown in FIG. 7, upstream water level sensor 36 sends signals over a communication link 42 to controller 40 representative of a change in water level beyond a predefined safety limit and/or stoppage of the rotor. Communication link 42 can be wired or wireless. The controller 40 operatively connects with a hydraulic cylinder 44 that includes piston 48 operatively connected to a pivotable sole plate 6 for lowering and raising the sole plate 6 in a well-known manner.

In the event of a stoppage of rotation of the rotor or generator, sole plate 6 can be moved immediately from its first position substantially tangential to rotor 1, to a second safe position, indicated by dashed lines, that is level with the upper surface of foundation 26 or the stream bed. Lowering the sole plate to the safe position would ensure passage of the full discharge of the watercourse, clear of the bottom of the rotor, in the event of a stoppage.

### Basis of Design and Method of Control

Design of the sole plate, radial gate, and hinged flap follows conventional hydraulic and structural engineering principles in which hydrostatic and hydrodynamic load pressures are calculated and the material, shape, and size of the various components determined by hydrodynamic and mathematical analysis to assure that losses are minimized and that allowable stresses and deflections established by applicable standards and codes of practice are not exceeded.

Overall stability of the water turbine support structure must also be analyzed to assure the necessary factor of safety against sliding or overturning and that required anchorage devices and foundation materials are sufficient and adequate for the purpose. Depending upon the length of the wheel, a plurality of circular disc stiffeners disposed along the length of the wheel define the ends of the vanes as well as provide lateral stability for the wide aspect ratio water wheel. Support bearings at either end of the wheel must be constructed to resist not only transverse but also any longitudinal forces that may be imposed by transient flow conditions.

Raising or lowering the radial gate and hinged flaps require the use of wire cable and winches that can either be manually or electrically and/or automatically operated. In order to lower the main radial gate, the weight must either exceed the frictional resistance to such movement, or additional means such as downward pulling wire ropes, jacks or some kind of extra weight must be added to make closure possible.

Operation of the radial gate 2 and hinged flap gate 4 is achieved by raising both components from the fully closed position until the maximum allowable upstream water surface elevation can be maintained in a stable manner indicating that inflow from the upstream source equals outflow under the gate at maximum available head difference. Such a gate setting will cause the undershot impulse jet water turbine to generate maximum power. As inflows change, the upstream water level sensor will detect a rise or fall in the upstream water surface elevation I and automatically raise or lower the radial gate assembly accordingly

### Conditions For Maximum Power Output

Referring to FIGS. 1, 2A, 2B and 5, conditions for maximum power output for a given volume of discharge Q and available gross head H are as follows:
Minimum expansion of the jet can be achieved by shaping the curvature of the upper and lower approach surfaces of the gate lip and sole plate that constitute the nozzle to equal the maximum height of the opening (h). Such a condition provides a coefficient of discharge that is close to 1.0.
Absorption of as much of the kinetic energy as possible from the jet can be achieved by deflecting the water stream 90° and by allowing gravity to assist in discharging the water directly downwards into tail water compared to a generally horizontal direction of approach.
Reducing entry losses to a minimum is achieved by curving the shape of the vanes such that the vane surface at entry of the jet is parallel to the direction of the approaching flow and is shaped with a curve that turns the water in the jet through at least a 90 degree angle before discharge into the tailwater.
   Power output in kilowatts is given by the following:

$$Power output in kilowatts = \frac{η xQx ( H - h / 2 )}{11.8}$$

Q=cubic feet per second flow
H=gross head difference in feet between upstream and downstream water levels
h=height in feet of the opening below the radial gate and above the top of the sole plate

$$η = overall efficiency in terms of \frac{energy delivered}{energy available}$$

### Operational Features and Functional Mode

As the radial gate is raised, a rectangular jet of water is released between the lower edge of the gate and the upper surface of the sole plate. This jet impinges tangentially on the inside upper surface of each vane in turn and is then deflected downwards along the vane's inner surface towards the tail water downstream of the installation. As the rotor turns, the jet is interrupted by the following vane and water from the preceding vanes drops into the tail water downstream of the water turbine effectively at right angles to the direction of the jet. The kinetic energy of the jet is thus increasingly transferred to the water turbine by each vane in turn passing in front of the jet.

While the invention has been described in connection with what are presently considered to be the most practical and preferred embodiments, it is to be understood that the invention is not limited to the disclosed embodiments, but rather is intended to cover various modifications and equivalent arrangements which are included within the scope of the following proposed claims.

For example, a plurality of water turbines according to the invention could be communicatively networked by many different conventional control systems along an entire irrigation system. This arrangement would enable automated monitoring of water flow and surface water levels at each radial gate. Thus, a series of networked water turbine s and included radial gates would enable surface water levels throughout an entire irrigation system to be closely controlled for optimal water allocation.

However, such concepts necessarily employ the moveable radial gate and improved control surfaces for maximizing the kinetic energy available in the jet. Therefore, persons of ordinary skill in this field are to understand that all such equivalent arrangements and modifications are to be included within the scope if the following claims.

I claim:

1. An undershot impulse-jet driven water turbine including a generator for generating electric power, for placement in a watercourse with upstream banks high enough to contain water elevations of sufficient difference to develop a hydraulic head comprising:
a cylindrical rotor for placement transversely in the watercourse;
a plurality of vanes disposed radially about the rotor, the rotor connected for powering the generator, each vane having a leading edge defining a surface for impacting a jet of water formed from a flow nozzle;
a radial gate disposed with minimal clearance about the circumference of the vanes over an upstream portion of the rotor for maximizing the hydraulic head at the jet under varying conditions of discharge and to actively maintain an upstream water level within defined limits at any predetermined elevation, limited only by the height of the banks;
a sole plate disposed in the bed of the watercourse and having a control surface disposed substantially tangential to the radial gate, the control surface of the sole plate rising above normal tail water elevation and being characterized by a cross-sectional shape for focusing the jet such that it neither contracts nor expands;
a nozzle provided on the radial gate opposite the sole plate and cooperating with the sole plate control surface for directing the jet such that it impacts the vanes at an angle substantially normal to each vane leading edge;
a support plate coextensive with each vane, extending from a distal end of the leading edge of a first vane to a base of the leading edge of a successive vane, defining a control surface for streamlining the jet, as the jet approaches each leading edge.

2. An undershot impulse-jet driven water wheel for generating electric power as in claim 1 further comprising; one or more radial discs provided about the circumference of the rotor for supporting the vanes, such that each radial disc separates a first set of vanes from an adjacent set of vanes, and the vanes in adjacent sets are offset radially to prevent vibration.

3. An undershot impulse-jet driven water wheel for generating electric power as in claim 1 a further comprising:
a water level sensor disposed upstream of the radial gate and communicatively linked to the controller for sensing upstream water levels and for activating the controller to move the sole plate to a position allowing free water passage when sensed water level is beyond a defined safety limit.

4. An undershot impulse-jet driven water wheel for generating electric power as in claim 3 further comprising:
a lifting/lowering system of mechanical or hydraulic jacks responsive to the controller for raising or lowering the water turbine and generator together to clear a floodway and/or provide maintenance access.

5. An impulse-jet driven water wheel for generating electric power, for placement in a watercourse with upstream banks high enough to contain water elevations of sufficient difference to develop a hydraulic head comprising:
a cylindrical rotor for placement transversely in the watercourse;
plurality of vanes disposed radially about the rotor, the rotor connected for powering a generator, each vane provided for impacting a jet of water formed from a nozzle;
a radial gate disposed with minimal clearance about the circumference of the vanes over an upstream portion of the rotor for maximizing the hydraulic head at the jet under varying conditions of discharge;
a sole plate disposed in the bed of the watercourse and having a control surface disposed substantially tangential to but not contacting the radial gate, the control surface of the sole plate rising above normal tail water elevation and being characterized by a cross-sectional shape for minimizing expansion of the jet;
a nozzle provided on the radial gate opposite the sole plate and cooperating with the sole plate control surface for shaping the jet that such that it impacts the vanes at an angle substantially normal to each vane first surface;
a plurality of control surfaces, each coextensive with a corresponding vane, extending from a distal end of a first vane to a base of a successive vane, such that the control surface defines a streamlined flow path for the jet's impact with each successive vane.

6. An undershot impulse-jet driven water turbine for generating electric power, for placement in a watercourse with upstream banks high enough to contain water elevations of sufficient difference to develop a hydraulic head comprising:
a cylindrical rotor connected for powering a generator; for placement with a longitudinal axis transversely in the watercourse
a plurality of vanes disposed radially about the rotor, each vane having a leading edge defining a surface for impacting a jet of water formed from a flow nozzle, and having a control surface extending from the leading edge of a first vane to a base of a successive vane for defining a streamlined flow path for the jet;
a radial gate disposed with minimal clearance about the circumference of the vanes over an upstream portion of the rotor for maximizing the hydraulic head at the jet under varying conditions of discharge and to actively maintain an upstream water level within defined limits at any predetermined elevation, limited only by the height of the banks;
a sole plate disposed in the bed of the watercourse and having a control surface disposed substantially tangential to, but not contacting the radial gate, the control surface of the sole plate rising above normal tail water elevation and being characterized by a cross-sectional shape for minimizing expansion of the jet as it enters the vanes;
a nozzle provided on the radial gate opposite the sole plate and cooperating with the sole plate control surface for shaping the water stream into a jet that impacts the vanes at an angle substantially normal to each vane surface.

7. An impulse-jet driven water wheel for generating electric power according to claim 6, wherein the control surface defines a cavity extending beneath the control surface from the leading edge of a first vane to the base of a second vane, and the cavity is filled with foam plastic or similar lightweight, non-absorbent material to prevent ingress of water.

8. An impulse-jet driven water wheel for generating electric power according to claim 6 further comprising a plurality of discs provided concentrically along the longitudinal axis of the rotor for supporting the vanes, and separating the vanes into sets, such that the vanes of a first set are offset radially with respect to the vanes of a second set.

9. A method for forming and streamlining a high velocity jet and reducing turbulent flow in an undershot impulse-jet driven water turbine including a cylindrical rotor driving a generator for generating electric power, comprising the steps of:
placing the cylindrical rotor transversely in a watercourse above its bed for creating a useful hydraulic head upstream of the rotor;
providing a plurality of vanes radially about the rotor for impacting a jet of water;
maximizing the hydraulic head of the jet under varying conditions of discharge by placing a radial gate with minimal clearance about the circumference of the vanes over an upstream portion of the rotor;
forming a jet of water with a nozzle provided on the radial gate for impacting the vanes at an angle substantially normal to a leading edge of each vane;
focusing the jet with a control surface on the bed of the watercourse substantially tangential to the radial gate, such that the jet neither contracts nor expands;
streamlining the approach of the jet for non turbulent impact with the leading edge of each vane for maximizing the kinetic energy extracted from the jet.

10. A method for forming and streamlining a high velocity jet and reducing turbulent flow in an undershot impulse-jet driven water turbine as in claim 9, wherein the step of streamlining the jet further comprises defining a flow path for the jet between successive vanes by aligning a flow control surface between the leading edge of a first vane and the base of a second vane for substantially eliminating turbulence and vortices in the jet as the jet impacts successive vanes.

11. A method for forming and streamlining a high velocity jet and reducing turbulent flow in an undershot impulse-jet driven water turbine as in claim 9, further comprising the step of dividing the vanes into sets and offsetting radially the vanes of each set with respect to the vanes of an adjacent set.
